(19) United States
(12) Patent Application Publication
(10) Pub. No.: US 2026/0290872 A1
(43) Pub. Date: Sep. 24, 2026

(54) STACKING DEVICE AND METHOD FOR MANUFACTURING ALL-SOLID-STATE BATTERY USING THE SAME

(71) Applicant: SAMSUNG SDI CO., LTD., Yongin-si, Gyeonggi-do (KR)

(72) Inventors: Daeyoung JI, Yongin-si, Gyeonggi-do (KR); Sung-Hyun CHOI, Yongin-si, Gyeonggi-do (KR); Sanghoon CHOI, Yongin-si, Gyeonggi-do (KR); Chanjin CHOI, Yongin-si, Gyeonggi-do (KR); Hyungnoh JUNG, Yongin-si, Gyeonggi-do (KR)

(73) Assignee: SAMSUNG SDI CO., LTD., Yongin-si, Gyeonggi-do (KR)

(21) Appl. No.: 18/880,213

(22) PCT Filed: Feb. 28, 2024
(86) PCT No.: PCT/KR2024/002597

§ 371 Date: Dec. 30, 2024

(30) Foreign Application Priority Data
Oct. 20, 2023 (KR) 10-2023-0141164

(51) Int. Cl. H01M 10/04; H01M 4/04; H01M 10/0562

(52) U.S. Cl. CPC H01M 10/0404; H01M 4/0435; H01M 10/0468; H01M 10/0562; H01M 2300/0065

(57) ABSTRACT

The present invention relates to a stacking device and a method for manufacturing an all-solid-state battery using the same. More particularly, a stacking device according to the present invention includes a web supply unit, a magazine unit, a sheet supply unit, and a sheet fixing unit. The sheet fixing unit includes a circulation belt and a clamp provided on one side of the circulation belt, the circulation belt is configured such that the clamp circularly travels in a first direction, and the clamp is configured to fix an electrode sheet onto a pouch web.

### TECHNICAL FIELD

The present invention relates to a stacking device and a method for manufacturing an all-solid-state battery using the same.

### BACKGROUND ART

Lately, extensive efforts to develop batteries having high energy density and enhanced safety have been made in response to industrial demand. For example, lithium ion batteries have been put to practical use in automobiles, as well as information related appliances and communication devices. In the field of automobiles, safety is particularly stressed because failures are highly likely to cause harm to lives.

All-solid-state batteries replacing an electrolyte solution with a solid electrolyte are being suggested. The all-solid-state batteries use no combustible organic dispersion medium, and may thus have significantly reduced chances of causing fires or explosions even when short circuits take place.

### DISCLOSURE

### Technical Problem The present invention provides a stacking device for an all-solid-state rechargeable battery.

The present invention also provides a method for manufacturing an all-solid-state battery using the stacking device described above.

### Technical Solution

According to an embodiment of the present invention, provided is a stacking device including a web supply unit, a magazine unit, a sheet supply unit, and a sheet fixing unit, wherein the web supply unit is configured such that a pouch web travels in a first direction, the pouch web includes a space for receiving an electrode sheet, the magazine unit is configured to receive a plurality of electrode sheets, the sheet supply unit is configured such that the electrode sheet is picked up from the magazine unit and seated in the space of the pouch web, the sheet fixing unit includes a circulation belt and a clamp provided on one side of the circulation belt, the clamp is configured to fix the electrode sheet seated in the space onto the pouch web, and the circulation belt is configured such that the clamp circularly travels in the first direction.

According to another embodiment of the present invention, provided is a method for manufacturing an all-solid-state battery, including subjecting a pouch web to travel along a first direction where the pouch web includes a space for receiving an electrode sheet, subjecting a first electrode sheet to be seated in the space of the traveling pouch web, fixing the seated first electrode sheet with a first clamp, subjecting the first clamp fixing the first electrode sheet to travel along the first direction, and detaching the first clamp from the first electrode sheet.

### Advantageous Effects

Using a stacking device of the present invention, a sheet-like electrode may be stacked, and subsequently, a monocell may be manufactured through line pressing.

Using a method for manufacturing an all-solid-state battery of the present invention, a monocell may be manufactured through a line process.

### DESCRIPTION OF DRAWINGS

FIG. 1 is a cross-sectional view for describing an all-solid-state battery according to embodiments of the present invention;

FIG. 2 is a front view for describing a method for manufacturing an all-solid-state battery according to embodiments of the present invention;

FIG. 3 is a perspective view for describing a stacking device for an all-solid-state battery according to embodiments of the present invention;

FIGS. 4A and 4B are perspective views for describing a pouch web according to embodiments of the present invention; and

FIGS. 5 through 16 are perspective views for describing a method for manufacturing an all-solid-state battery according to embodiments of the present invention.

### MODE FOR INVENTION

In order to sufficiently understand the configuration and effects of the present invention, preferred embodiments of the present invention will be described with reference to the accompanying drawings. It should be noted, however, that the present invention is not limited to the following embodiments, and may be implemented in various forms and variously modified. The embodiments herein are provided so that present invention will be thorough and complete and will fully convey the scope of the present invention to those skilled in the art.

Herein, it will be understood that when a component is referred to as being on another component, the component may be directly on another component, or an intervening third component may be present. In addition, in the drawings, thicknesses of components are exaggerated for effectively describing technical contents. Like reference numerals refer to like elements throughout.

The embodiments described herein will be explained with reference to the cross-sectional views, plan views, and/or perspective views as ideal example views of the present invention. Although the terms such as first and second are used to describe various components in various embodiments of this specification, the components should not be limited to these terms. These terms are used only to distinguish one component from another component. Embodiments described and exemplified herein include complementary embodiments thereof.

Terms used herein are not for limiting the present invention but for describing the embodiments. As used herein, the singular forms include the plural forms as well, unless the context clearly indicates otherwise. The meaning of “comprises” and/or “comprising” used herein does not exclude the presence or addition of one or more other components besides a mentioned component.

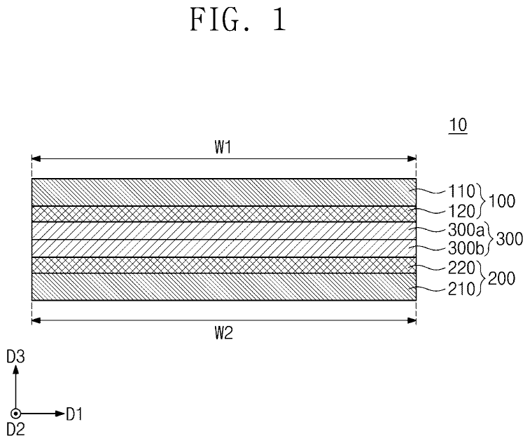

FIG. 1 is a cross-sectional view for describing an all-solid-state battery according to embodiments of the present invention. Referring to FIG. 1, a monocell 10 of an all-solid-state battery according to an embodiment of the present invention is presented as an example. The monocell 10 may include a positive electrode layer 100, a negative electrode layer 200 facing the positive electrode layer 100, and a solid electrolyte layer 300 disposed between the positive electrode layer 100 and the negative electrode layer 200. However, the embodiment of the present invention is not limited thereto, and the monocell 10 may further include an additional functional layer disposed between the positive electrode layer 100 and the solid electrolyte layer 300 or between the negative electrode layer 200 and the solid electrolyte layer 300, such as an adhesion enhancing layer.

The positive electrode layer 100 may include a positive electrode current collector 110 and a positive electrode active material layer 120 on the positive electrode current collector 110. The positive electrode active material layer 120 may include a positive electrode active material, a solid electrolyte, a conductive material, and a binder.

The positive electrode current collector 110 may provide a reference surface on which the positive electrode active material layer 120 is disposed. The positive electrode current collector 110 may be in the form of a plate or a foil. For example, the positive electrode current collector 110 may include indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

Unlike what is shown in FIG. 1, the positive electrode current collector 110 may not be provided in an embodiment of the present invention. Although not shown, a carbon layer having a thickness of 0.1 μm to 4 μm may be further disposed between the positive electrode current collector 110 and the positive electrode active material layer 120 to increase binding strength between the positive electrode current collector 110 and the positive electrode active material layer 120.

The positive electrode active material may be a material capable of reversibly absorbing and desorbing lithium ions. For example, the positive electrode active material may include a lithium transition metal oxide such as lithium cobalt oxide (LCO), lithium nickel oxide, lithium nickel cobalt oxide, lithium nickel cobalt aluminum oxide (NCA), lithium nickel cobalt manganate (NCM), lithium manganate, or lithium iron phosphate; nickel sulfide; copper sulfide; lithium sulfide; iron oxide; or vanadium oxide, but the embodiment of the present invention is not limited thereto. The positive electrode active material may be used alone or may be a mixture of two or more types.

The lithium transition metal oxide may be, for example, a compound represented by any one among LiaA_{1-b}B_{b}D2 (0.90≤a≤1, 0<b≤0.5), LiₐE_{1-b}B_{b}O_{2-c}D_{c} (0.90≤a≤1, 0≤b≤0.5, 0≤c≤0.05), LiE_{2-b}B_{b}O_{4-c}D_{c} (0≤b≤0.5, 0≤c≤0.05), LiₐNi_{1-b-c}Co_{b}B_{c}D_{α} (0.90≤a≤1, 0≤b≤0.5, 0≤c≤0.05, 0<α<2), LiₐNi_{1-b-c}Co_{b}B_{c}O_{2-α}F_{α} (0.90≤a≤1, 0≤b≤0.5, 0≤c≤0.05, 0<cα<2), LiₐNi_{1-b-c}Mn_{b}B_{c}D_{α} (0.90≤a≤1, 0≤b≤0.5, 0≤c≤0.05, 0<α<2), LiₐNi_{1-b-c}Mn_{b}B_{c}O_{2-α}F_{α} (0.90≤a≤1, 0≤b≤0.5, 0≤c≤0.05, 0<α<2), LiₐNi_{b}E_{c}G_{d}O₂ (0.90≤a≤1, 0≤b≤0.9, 0≤c≤0.5, 0.001≤d≤0.1), LiₐNi_{b}Co_{c}Mn_{d}GeO₂(0.90≤a≤1, 0≤b≤0.9, 0≤c≤0.5, 0≤d<0.5, 0.001≤e≤0.1), LiₐNiG_{b}O₂ (0.9≤a≤1, 0.001<b≤0.1), LiₐCoG_{b}O₂(0.90≤a≤1, 0.001<b≤0.1), LiₐMnG_{b}O₂(0.90≤a≤1, 0.001<b≤0.1), LiₐMn₂G_{b}O₄(0.90≤a≤1, 0.001<b≤0.1), QO₂, QS₂, LiQS₂, V₂O₅, LiV₂O₅, LiIO₂, LiNiVO₄, Li_{3-f}J₂(PO₄)₃ (0≤f<2), Li_{3-f}Fe₂(PO₄)₃ (0≤f≤2), and LiFePO₄. In the compound, capital “A” is nickel (Ni), cobalt (Co), manganese (Mn), or a combination thereof; capital “B” is aluminum (Al), nickel (Ni), cobalt (Co), manganese (Mn), chromium (Cr), iron (Fe), magnesium (Mg), strontium (Sr), vanadium (V), a rare earth element, or a combination thereof; capital “D” is oxygen (O), fluorine (F), sulfur(S), phosphorus (P), or a combination thereof, capital “E” is cobalt (Co), manganese (Mn), or a combination thereof; capital “F” is fluorine (F), sulfur(S), phosphorus (P), or a combination thereof; capital “G” is (Al), chromium (Cr), manganese (Mn), iron (Fe), magnesium (Mg), lanthanum (La), cerium (Ce), strontium (Sr), vanadium (V), or a combination thereof; capital “Q” is titanium (Ti), molybdenum (Mo), manganese (Mn), or a combination thereof, capital “I” is chromium (Cr), vanadium (V), iron (Fe), scandium (Sc), yttrium (Y), or a combination thereof; and capital “J” is vanadium (V), chromium (Cr), manganese (Mn), cobalt (Co), nickel (Ni), copper (Cu), or a combination thereof.

The positive electrode active material may include, for example, a lithium salt of the transition metal oxide that has a layered rock salt type structure among the examples of the lithium transition metal oxide. For example, the “layered rock salt type structure” indicates a structure in which oxygen atomic layers and metal atomic layers are alternately arranged regularly in a <111> direction of a cubic rock salt type structure, and as a result, each atomic layer forms a two-dimensional plane. The “cubic rock salt type structure” indicates a sodium chloride (NaCl) type structure, which is one type of crystal structures, and in particular, a structure in which face centered cubic (fcc) lattices formed by respective anions and cations are misaligned with respect to each other by ½ of the ridge of a unit lattice. The lithium transition metal oxide having this layered rock salt type structure may be a ternary lithium transition metal oxide, such as LiNiₓCo_{y}Al_{z}O₂ (NCA) or LiNiₓCo_{y}Mn_{z}O₂ (NCM) (0<x<1,0<y<1, 0<z<1, x+y+z=1). When the positive electrode active material includes a ternary lithium transition metal oxide having a layered rock salt type structure, the all-solid-state battery 10 may have greater energy density and improved thermal stability.

The above-described compounds included in the positive electrode active material may be covered by a coating layer (not shown). The positive electrode active material may also be used as a mixture of the above-described compounds and a compound to which a coating layer is added. Meanwhile, the coating layer added to a surface of the positive electrode active material may include, for example, oxide, hydroxide, oxyhydroxide, oxycarbonate, or hydroxycarbonate of the following coating elements. The compounds forming the coating layer may be amorphous or crystalline. The coating elements included in the coating layer may be Mg, Al, Co, K, Na, Ca, Si, Ti, V, Sn, Ge, Ga, B, As, Zr, or a mixture thereof. The coating layer may include, for example, Li₂O—ZrO₂ (LZO). The coating layer may be formed using any method that does not adversely affect the physical properties of the positive electrode active material. For example, the coating layer may be formed using a spray coating method or a dipping method.

When the positive electrode active material includes nickel (Ni) as a ternary lithium transition metal oxide such as NCA or NCM, the capacity density of the all-solid-state battery 10 may increase, and thus the metal elution of the positive electrode active material may be reduced in a charged state. Accordingly, the all-solid-state battery 10 may have improved cycle characteristics in a charged state. Meanwhile, the “cycle characteristics” are characteristics that indicate the degree to which the all-solid-state battery 10 is deteriorated due to charging/discharging of the all-solid-state battery 10, and in an all-solid-state battery 10 having high cycle characteristics, the degree of deterioration caused by charging/discharging may be insignificant, and in an all-solid-state battery 10 having low cycle characteristics, the degree of deterioration caused by charging/discharging may be significant.

The shape of the positive electrode active material may include, for example, particle shapes such as spheres and ellipsoids. The particle size and content of the positive electrode active material are not particularly limited.

The solid electrolyte may include a sulfide-based solid electrolyte having excellent lithium ion conductivity characteristics. The sulfide-based solid electrolyte may include, for example, at least one selected from Li₂S—P₂S₅, Li₂S—P₂S₅—LiX (where X is a halogen element), Li₂S-P₂S5—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ(where m and n are positive numbers, and capital “Z” is one of Ge, Zn, or Ga), Li₂S—GeS₂, Li₂S—SiS₂—Li₃PO₄, Li₂S—SiS₂—LiₚMO_{q} (where p and q are positive numbers, and “M” is one of P, Si, Ge, B, Al, Ga, or In), Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2).

The sulfide-based solid electrolyte may be an argyrodite-type compound containing at least one selected from, for example, Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be an argyrodite-type compound containing at least one selected from, for example, Li₆PS₅Cl, Li₆PS₅Br, and Li₆PS₅I. The argyrodite-type solid electrolyte may have a density of 1.5 g/cc to 2.0 g/cc. The argyrodite-type solid electrolyte, when having a density of 1.5 g/cc or greater, may allow all-solid-state batteries to have reduced internal resistance and prevent solid electrolyte membranes from showing defects such as penetration and short-circuits caused by formation of lithium dendrites. The solid electrolyte may have an elastic modulus of, for example, 15 GPa to 35 GPa.

The solid electrolyte included in the positive electrode active material layer 120 may have a smaller average (median) particle size (D50) than the solid electrolyte included in the solid electrolyte layer 300. For example, the average (median) particle size (D50) of the solid electrolyte included in the positive electrode active material layer 120 may be 90% or less, 80% or less, 70% or less, 60% or less, 50% or less, 40% or less, 30% or less, or 20% or less of the average (median) particle size (D50) of the solid electrolyte included in the solid electrolyte layer 300. Meanwhile, the average (median) particle size (D50) may be a median diameter measured using a laser particle size distribution meter.

The positive electrode active material layer 120 may include a conductive material. The conductive material has conductivity without causing chemical changes in the all-solid-state battery 10, and may thus increase the conductivity of the positive electrode active material and the solid electrolyte. The conductive material may include a carbon-based material. The conductive material may include, for example, at least one selected from graphite, carbon black, acetylene black, carbon nanofibers, and carbon nanotubes.

The positive electrode active material layer 120 may further include a binder. The binder may bond the positive electrode active material, the solid electrolyte, and the conductive material contained in the positive electrode active material layer 120, and may include a material designed to improve bonding strength with the positive electrode current collector 110. The binder may include, for example, polyvinylidene fluoride, styrene butadiene rubber (SBR), polytetrafluoroethylene, polyvinylidenefluoride, vinylidene fluoride/hexafluoropropylene copolymer, polyacrylonitrile, or polymethyl methacrylate.

The positive electrode active material layer 120 may include 85 parts by weight to 92 parts by weight of the positive electrode active material with respect to 100 parts by weight of the positive electrode active material, the solid electrolyte, the conductive material, and the binder. The positive electrode active material layer 120 may include 0.5 parts by weight to 1.5 parts by weight of the binder.

In the positive electrode active material layer 120, the conductive material may be present in an amount of 1 part by weight to 50 parts by weight with respect to 100 parts by weight of the solid electrolyte. When the conductive material is present in an amount of less than 1 part by weight with respect to 100 parts by weight of the solid electrolyte, the positive electrode active material layer 120 may have reduced electrical conductivity. When the conductive material is present in an amount of greater than 50 parts by weight with respect to 100 parts by weight of the solid electrolyte, the proportion of the conductive material goes up too high, and thus a coating layer covering a surface of the solid electrolyte may not be properly formed.

According to embodiments, the positive electrode active material layer 120 may further include at least one additive selected from the group consisting of a filler, a coating agent, a dispersant, and an ion conductive auxiliary agent, in addition to the positive electrode active material, the solid electrolyte, the conductive material, and the binder described above.

The solid electrolyte layer 300 may be disposed between the positive electrode layer 100 and the negative electrode layer 200 and may include a sulfide-based solid electrolyte having excellent lithium ion conductivity characteristics. The solid electrolyte included in the solid electrolyte layer 300 may be the same as or different from any one of the materials that may be included in the solid electrolyte included in the positive electrode active material layer 120 described above.

The solid electrolyte layer 300 of an embodiment may include a sulfide-based solid electrolyte. The sulfide-based solid electrolyte may be prepared by subjecting starting materials (e.g., Li₂S, P₂S₅) to melt-quenching or mechanical milling. In addition, subsequently, the resulting product may be heat-treated. The solid electrolyte may be amorphous, crystalline, or a mixture thereof. In addition, the solid electrolyte may include at least sulfur(S), phosphorus (P), and lithium (Li), as component elements among the sulfide-based solid electrolyte materials described above. For example, the solid electrolyte may be a material containing Li₂S—P₂S₅. When the material containing Li₂S—P₂S₅ is used as a sulfide-based solid electrolyte material that forms the solid electrolyte, a mixing molar ratio of Li₂S and P₂S₅(Li₂S:P₂S₅) is, for example, in a range of 50:50 to 90:10.

The sulfide-based solid electrolyte may be an argyrodite-type compound containing at least one selected from, for example, Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be an argyrodite-type compound containing at least one selected from, for example, Li₆PS₅Cl, Li₆PS₅Br, and Li₆PS₅I. The argyrodite-type solid electrolyte may have a density of 1.5 g/cc to 2.0 g/cc. The argyrodite-type solid electrolyte, when having a density of 1.5 g/cc or greater, may allow all-solid-state batteries to have reduced internal resistance and prevent solid electrolyte membranes from showing defects such as penetration and short-circuits caused by formation of lithium dendrites. The solid electrolyte has an elastic modulus of, for example, 15 GPa to 35 GPa.

The solid electrolyte layer 300 may further include a binder. The binder in the solid electrolyte layer 300 is, for example, styrene butadiene rubber (SBR), polytetrafluoroethylene, polyvinylidene fluoride, and polyethylene, but the embodiment of the present invention is not limited thereto. The binder of the solid electrolyte layer 300 may be the same as or different from the binder included in the positive electrode active material layer 120 or the binder included in the negative electrode coating layer 220.

The negative electrode layer 200 may include a negative electrode current collector 210 and a negative electrode coating layer 220 on the negative electrode current collector 210. The negative electrode current collector 210 may provide a reference surface on which the negative electrode coating layer 220 is disposed. For example, the negative electrode current collector 210 may include a material that is not reactive with lithium, i.e., does not form either an alloy or a compound with lithium. For example, the negative electrode current collector 210 may include at least one metal selected from the group consisting of copper (Cu), stainless steel, titanium (Ti), iron (Fe), cobalt (Co), and nickel (Ni). The negative electrode current collector 210 may have a thickness of 1 μm to 20 μm, more specifically 5 μm to 15 μm, more specifically 7 μm to 10 μm.

The negative electrode current collector 210 may be composed of one of the above-described metals, or may include an alloy of two or more metals or a coating material. The negative electrode current collector 210 may be, for example, in the form of a plate or a foil. Meanwhile, in an embodiment, the negative electrode current collector 210 may not be provided.

The negative electrode coating layer 220 may allow lithium metal to grow between the negative electrode coating layer 220 and the negative electrode current collector 210 when the all-solid-state battery 10 is charged. The negative electrode coating layer 220 may serve as a protection layer for lithium metal and also inhibit the deposition and growth of lithium dendrites.

The negative electrode coating layer 220 may include metal and carbon. For example, the negative electrode coating layer 220 may include at least one metal selected from the group consisting of gold (Au), platinum (Pt), palladium (Pd), silicon (Si), silver (Ag), aluminum (Al), bismuth (Bi), tin (Sn), and zinc (Zn). The negative electrode coating layer 220 may include at least one carbon selected from the group consisting of carbon black, acetylene black, furnace black, ketjen black, and graphene. In an embodiment, the negative electrode coating layer 220 may include a mixture of carbon black and silver (Ag).

The negative electrode coating layer 220 may further include other additives in addition to metal and carbon. The negative electrode coating layer 220 may further include at least one additive selected from the group consisting of, for example, a binder, a filler, a coating agent, a dispersant, and an ion conductive auxiliary agent.

The negative electrode coating layer 220 may have a smaller thickness than the positive electrode active material layer 120. The thickness of the negative electrode coating layer 220, is, for example, 50% or less, 40% or less, 30% or less, 20% or less, 10% or less, or 5% or less of the thickness of the positive electrode active material layer 120. The negative electrode coating layer 220 may have a thickness of, for example, 1 μm to 20 μm, 2 μm to 10 μm, or 3 μm to 7 μm. When the negative electrode coating layer 220 is too thin, the lithium dendrites formed between the negative electrode coating layer 220 and the negative electrode current collector 210 break down the negative electrode coating layer 220, and this may cause the all-solid-state battery 10 to have degraded cycle characteristics. When the negative electrode coating layer 220 is too thick, the all-solid-state battery 10 has reduced energy density and greater internal resistance due to the negative electrode coating layer 220, and this may cause the all-solid-state battery 10 to have degraded cycle characteristics.

Meanwhile, although not shown, a carbon layer designed to improve adhesion between the negative electrode coating layer 220 and the solid electrolyte layer 300 may be further included.

According to embodiments of the present invention, a width (or breadth) of the positive electrode layer 100 may be the same as a width (or breadth) of the negative electrode layer 200. For example, the positive electrode layer 100 may have a first width W1 in the first direction D1, and the negative electrode layer 200 may have a second width W2 in the first direction D1. The first width W1 may be the same as the second width W2.

According to embodiments of the present invention, a width (or breadth) of the positive electrode layer 100 may be smaller than a width (or breadth) of the negative electrode layer 200. For example, the first width W1 may be smaller than the second width W2.

According to embodiments of the present invention, a width (or breadth) of the positive electrode layer 100 may be greater than a width (or breadth) of the negative electrode layer 200. For example, the first width W1 may be greater than the second width W2.

The solid electrolyte layer 300 may include a positive electrode electrolyte layer 300a and a negative electrode electrolyte layer 300b. The positive electrode electrolyte layer 300a and the negative electrode electrolyte layer 300b may be stacked to form one solid electrolyte layer 300. The positive electrode electrolyte layer 300a may be in contact with the positive electrode active material layer 120, and the negative electrode electrolyte layer 300b may be in contact with the negative electrode coating layer 220.

In an embodiment of the present invention, the positive electrode electrolyte layer 300a and the negative electrode electrolyte layer 300b may include solid electrolytes of the same composition. In another embodiment of the present invention, the positive electrode electrolyte layer 300a and the negative electrode electrolyte layer 300b may include solid electrolytes of different compositions.

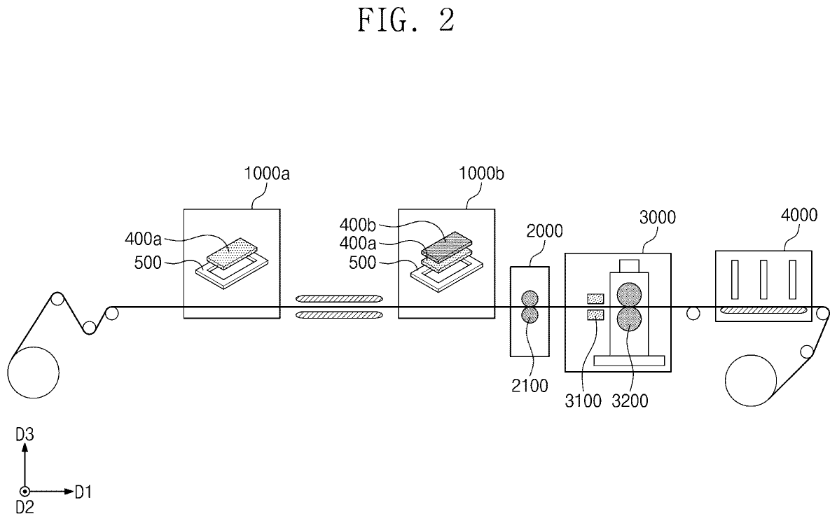

FIG. 2 is a front view for describing all-solid-state battery manufacturing equipment according to embodiments of the present invention.

Referring to FIG. 2, the all-solid-state battery manufacturing equipment of the present invention may include a first stacking device 1000a for stacking a first electrode sheet, a second stacking device 1000b for stacking a second electrode sheet, a lamination unit 2000, a press unit 3000, and a cell discharge unit 4000.

The first stacking device 1000a and the second stacking device 1000b may include the configuration of a stacking device 1000 which will be described later. For example, the first stacking device 1000a may be configured such that the first electrode sheet is seated on a pouch web 500. The second stacking device 1000b may be configured such that a second electrode sheet 400b is seated on the first electrode sheet 400a seated on the pouch web 500.

In an embodiment of the present invention, the lamination unit 2000 may be configured to attach the first electrode sheet 400a and the second electrode sheet 400b. For example, the lamination unit 2000 may include a pair of lamination rollers 2100. In an embodiment of the present invention, the lamination unit 2000 may roll a laminate 400c having the first electrode sheet 400a and the second electrode sheet 400b sequentially stacked therein to attach the first electrode sheet 400a and the second electrode sheet 400b.

In an embodiment of the present invention, the press unit 3000 may be configured to press the laminate 400c. In addition, the press unit 3000 may be configured to heat the first electrode sheet and the second electrode sheet. For example, the press unit 3000 may include a heater 3100 and a press roller 3200. In an embodiment of the present invention, the press unit 3000 may be configured to heat and then press the laminate 400c.

In an embodiment of the present invention, the cell discharge unit 4000 may be configured to discharge a manufactured cell on the pouch web 500. The pouch web 500 from which the cell is discharged may be wound around a pouch reel.

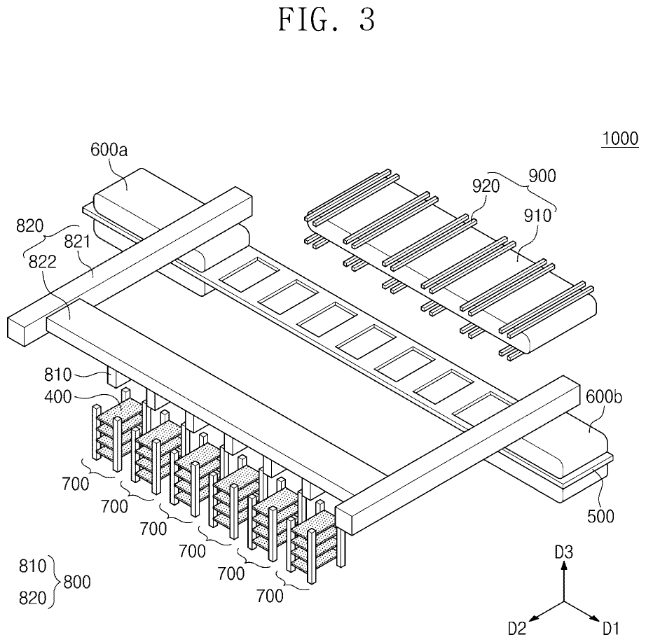

FIG. 3 is a perspective view for more specifically describing a stacking device of the all-solid-state battery manufacturing equipment according to embodiments of the present invention.

Referring to FIG. 3, the stacking device 1000 may include a web supply unit 600, a magazine unit 700, a sheet supply unit 800, and a sheet fixing unit 900.

A first web supply unit 600a and a second web supply unit 600b may be provided at each end of the stacking device 1000. Each of the first and second web supply units 600a and 600b may be configured such that the pouch web 500 travels in the first direction D1. For example, each of the first and second web supply units 600a and 600b may include a feeding belt 610 that enables the pouch web 500 to travel.

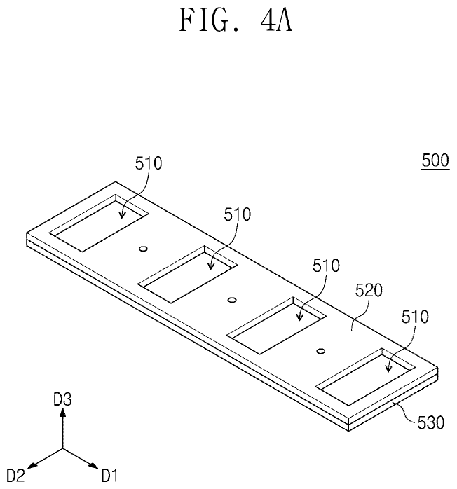

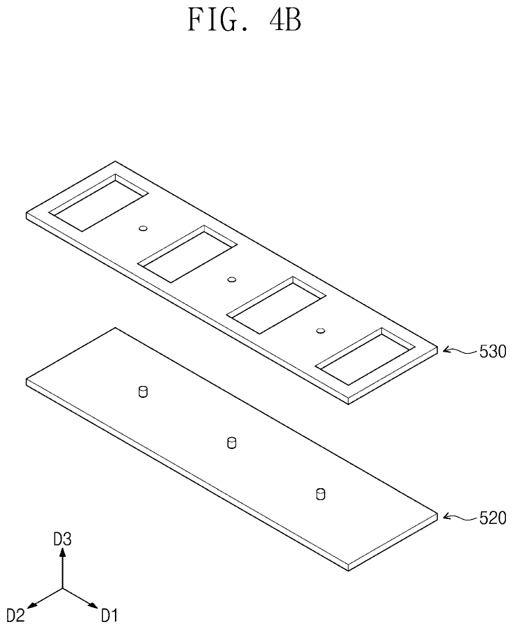

Referring to FIG. 4A, the pouch web 500 may include a space 510 capable of receiving an electrode sheet. An electrode sheet 400 may be seated in the space 510. The electrode sheet 400 may include the positive electrode layer 100 or negative electrode layer 200 described above with reference to FIG. 1. In an embodiment of the present invention, the electrode sheet 400 may include the positive electrode layer 100 or the negative electrode layer 200 and a solid electrolyte layer 300 (FIG. 1) formed thereon. For example, the electrode sheet 400 may include the positive electrode layer 100 and the positive electrolyte layer 300a (FIG. 1) formed thereon, or the negative electrode layer 200 and the negative electrolyte layer 300b (FIG. 1) formed thereon. In another embodiment of the present invention, a solid electrolyte layer may not be provided in the electrode sheet 400.

In an embodiment of the present invention, the pouch web 500 includes a plurality of spaces 510 arranged at a predetermined interval in the first direction D1, and thus a plurality of electrode sheets 400 may be seated at a predetermined interval in the first direction D1.

In an embodiment of the present invention, the space 510 may have a greater thickness than the monocell 10 described with reference to FIG. 1, thereby allowing the monocell 10 to move stably.

Referring to FIG. 4B, the pouch web 500 may be manufactured by bonding a guide gasket 530 having a plurality of holes formed on a bottom sheet 520. The plurality of holes may each correspond to the space 510. The hole formed in the guide gasket 530 may be of a size sufficient to allow the electrode sheet 400 to pass through.

Although not shown, the pouch web 500 may be manufactured by performing a deep drawing process on a bottom sheet made of a flexible material.

The pouch web 500 may travel along the first direction D1. The pouch web 500 may be supplied from an unwinding pouch reel. The pouch web 500 may be provided below the sheet supply unit 800 while moving along the first direction D1.

A plurality of electrode sheets 400 may be loaded into the magazine unit 700. The magazine unit 700 may be configured to sequentially supply the loaded electrode sheets 400. In an embodiment of the present invention, the electrode sheets 400 may be supplied from a plurality of magazine units 700, and thus a plurality of electrode sheets 400 may be supplied at once. The number of electrode sheets 400 supplied at once may vary depending on the travel speed of the pouch web 500. For example, when the travel speed of the pouch web 500 increases, the number of electrode sheets 400 supplied may increase.

The sheet supply unit 800 may include a sheet picking part 810 and a carrier 820. The sheet picking part 810 may be configured to pick up the electrode sheet 400 supplied from the magazine unit 700. For example, the sheet picking part 810 may include an adsorption means capable of adsorbing the electrode sheet 400. In an embodiment of the present invention, the sheet supply unit 800 may include a plurality of sheet picking parts 810 to pick up a plurality of electrode sheets 400.

The carrier 820 may be configured to transfer the picked electrode sheets 400 to the pouch web 500. For example, the carrier 820 may include a support 821 and a transport part 822. In an embodiment of the present invention, the transport part 822 moves the transfer sheet picking part 810 from the magazine unit 700 to the space 510 of the pouch web 500, and accordingly, the pouch web 500 may be provided below the sheet picking part 810.

The sheet fixing unit 900 may include a circulation belt 910 and a clamp 920 provided on one side of the circulation belt 910.

The circulation belt 910 may be configured such that the clamp 920 circulates along the first direction D1. For example, as the circulation belt 910 circulates, the clamp 920 provided on one side of the circulation belt 910 may travel along the electrode sheet 400 seated on the pouch web 500 in the first direction D1.

In an embodiment of the present invention, the circulation belt 910 may be configured such that the clamp 920 travels at the same speed as the pouch web 500.

In an embodiment of the present invention, the circulation belt 910 may continuously circulate without stopping, and accordingly, the clamp 920 may also continuously circulate without stopping.

Although not shown in the drawing, the sheet fixing unit 900 may further include a horizontal driving part and a vertical driving part that move the clamp 920. The horizontal driving part may be configured to move the clamp 920 in a second direction D2 crossing the first direction D1. The vertical driving part may be configured to move the clamp 920 in a vertical direction. In an embodiment of the present invention, the vertical driving part may be configured to move only one side of the clamp 920 in a vertical direction. Accordingly, the clamp 920 may move in the second direction D2 and then have one side thereof descended to be positioned on the electrode sheet 400.

The clamp 920 may be configured to fix the electrode sheet 400 on the pouch web 500. For example, the clamp 920 may fix the electrode sheet 400 by gripping the electrode sheet 400.

In an embodiment of the present invention, the clamp 920 may travel in the first direction D1 at the same speed as the pouch web 500. For example, a first speed of the pouch web 500 traveling in the first direction may be the same as a second speed of the clamp 920 traveling in the first direction.

In an embodiment of the present invention, the clamp 920 may travel in the first direction D1 while gripping the electrode sheet 400.

In an embodiment of the present invention, the sheet fixing unit 900 may include a plurality of clamps 920, and the plurality of clamps 920 may be arranged on the circulation belt at a predetermined interval along the first direction D1. The plurality of clamps 920 may fix each of the electrode sheets 400 that are seated on the pouch web 500.

Although not shown, the clamp 920 may further include a sensor. The sensor may detect when the electrode sheet 400 is seated on the pouch web 500. When the sensor detects the placement of the electrode sheet 400, the clamp may move to the seated electrode sheet 400 and fix the sheet 400.

The clamp 920 may be configured to unfix the fixed electrode sheet 400 before the fixed electrode sheet 400 enters the second web supply unit 600b or the lamination unit 2000. For example, the clamp 920 may be detached from the fixed electrode sheet 400 before the fixed electrode sheet 400 enters the second web supply unit 600b or the lamination unit 2000 to unfix the fixed electrode sheet 400.

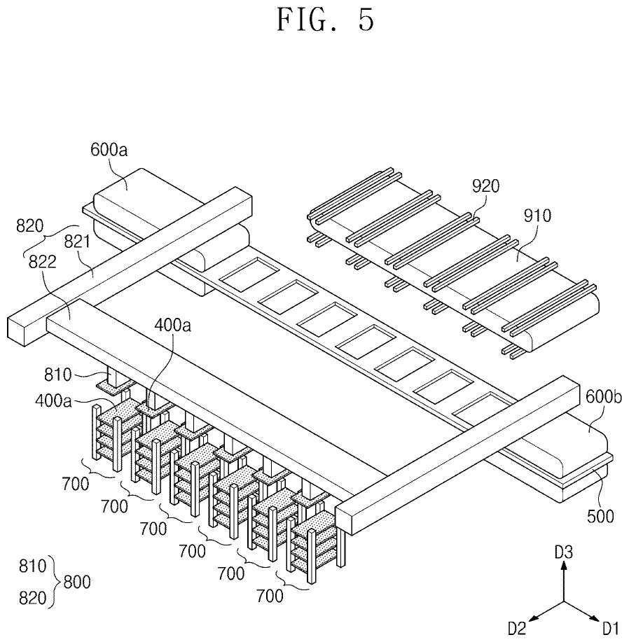

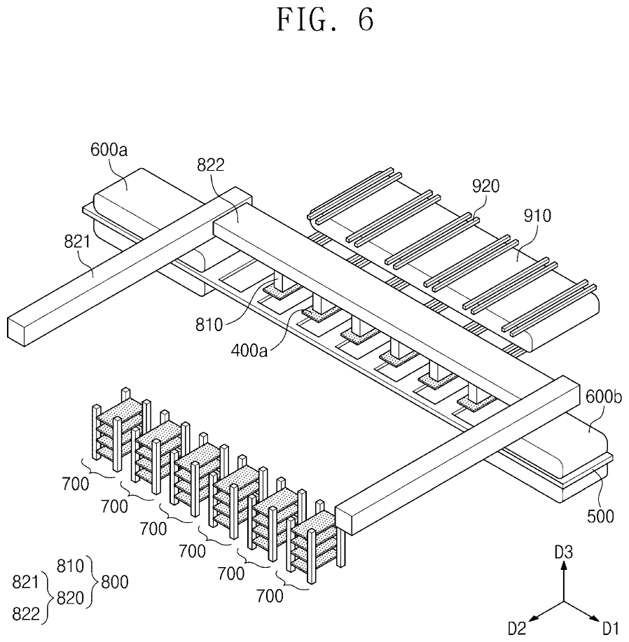

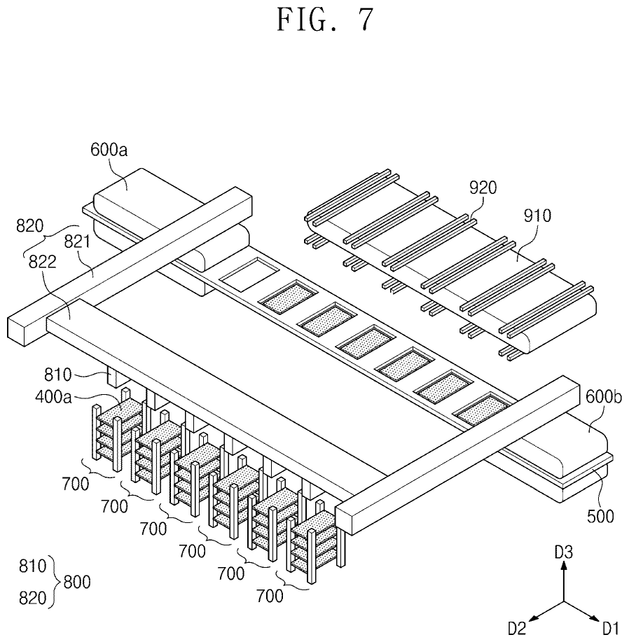

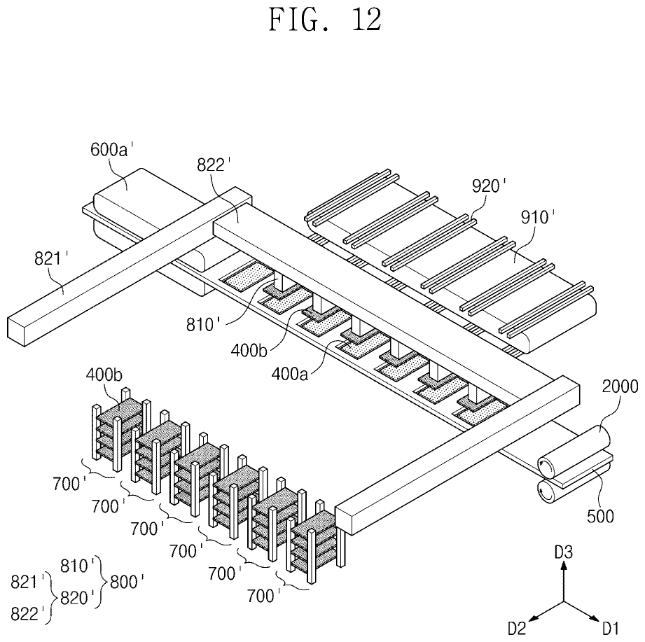

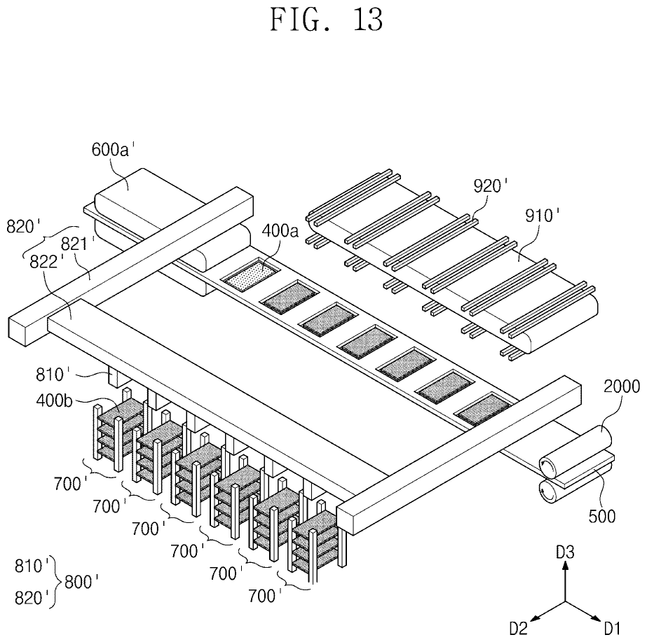

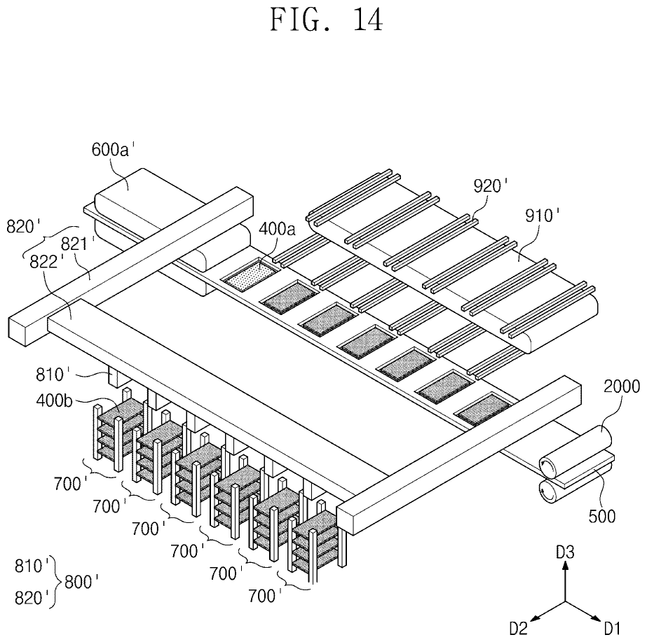

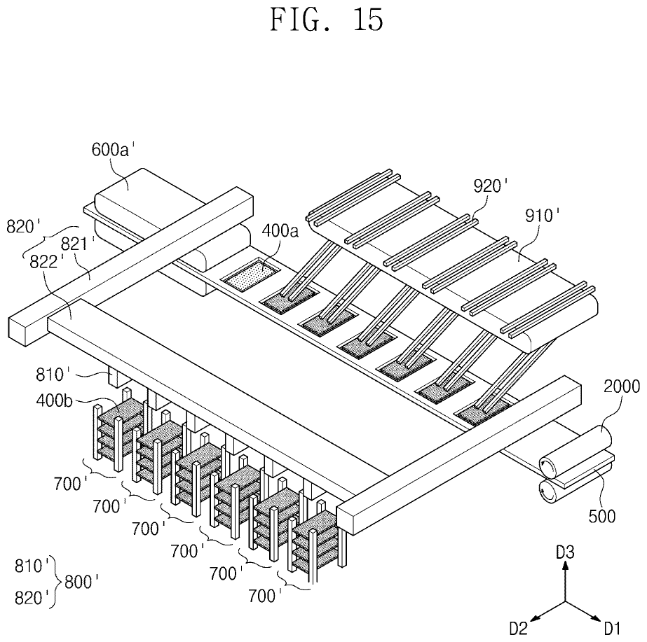

FIGS. 5 through 16 are cross-sectional views for describing a method for manufacturing an all-solid-state battery according to embodiments of the present invention. In the present embodiment, a method for manufacturing the all-solid-state battery of FIG. 1, using the stacking device described above with reference to FIG. 3, will be described. The first stacking device 1000a and the second stacking device 1000b are examples of the stacking device described above with reference to FIG. 3.

The first electrode sheet 400a and the second electrode sheet 400b are the same as the electrode sheet 400 described above, and are described as the first electrode sheet 400a and the second electrode sheet 400b according to the placement order thereof on the pouch web 500.

Referring to FIGS. 5 to 10, the first electrode sheet 400a may be seated on the pouch web 500 that travels using the first stacking device 1000a.

Referring to FIG. 5, the pouch web 500 may travel along the first direction D1. The pouch web may be supplied from an unwinding pouch reel, and the pouch web 500 may travel in the first direction D1 through the first and second web supply units 600a and 600b of FIG. 3. Specifically, the first and second web supply units 600a and 600b may be feeding belts.

Referring to FIGS. 5 to 7, the first electrode sheet 400a may be seated in the space 510 (see FIG. 4A) of the pouch web 500 through the sheet supply unit 800. For example, the sheet picking part 810 may adsorb the first electrode sheet 400a in the magazine unit 700. A carrier transports the sheet picking part 810 to the space 510 of the pouch web 500 and may thus enable the first electrode sheet 400a to be seated on the pouch web 500. After the first electrode sheet 400a is seated on the pouch web 500, the carrier 820 may transport the sheet picking part 810 back to the magazine unit 700. Accordingly, the sheet picking part 810 may be positioned on the first electrode sheet 400a to be seated next in the magazine unit 700.

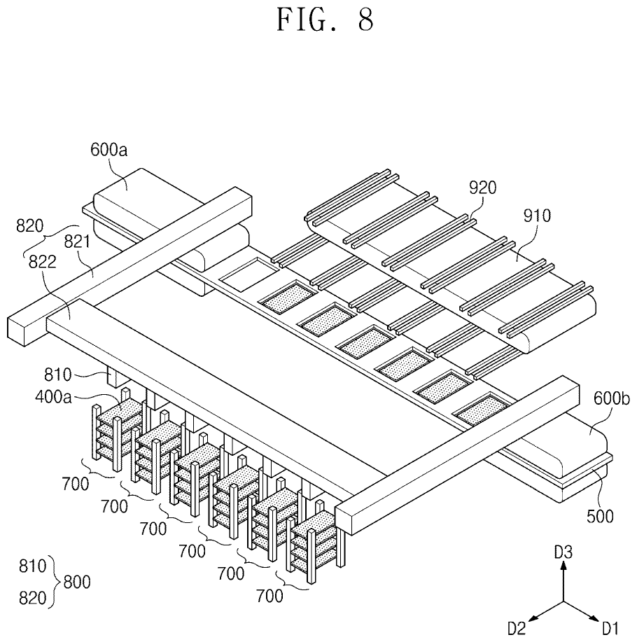

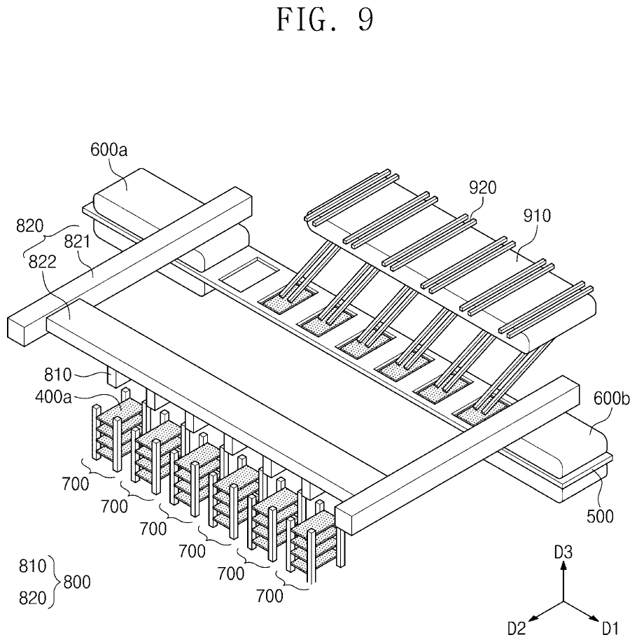

Referring to FIGS. 8 and 9, the first electrode sheet 400a seated on the pouch web 500 may be fixed through the sheet fixing unit 800. Specifically, a first clamp 920a provided on one side of the circulation belt 910 may fix the first electrode sheet 400a by gripping the first electrode sheet 400a seated on the pouch web 500. For example, the first clamp 920 may move in the second direction D2 and the vertical direction, and then grip and fix the first electrode sheet 400a.

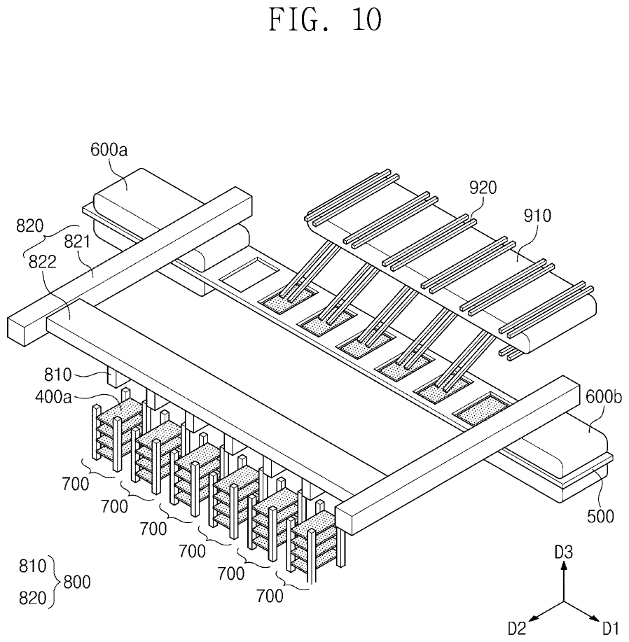

Referring to FIGS. 9 and 10, as the circulation belt 910 circulates, the first clamp 920 provided on one side of the circulation belt 910 may move in the first direction D1.

In an embodiment of the present invention, the first clamp 920 may travel in the first direction D1 at the same speed as the pouch web 500. For example, a first speed of the pouch web 500 traveling in the first direction may be the same as a second speed of the first clamp 920 traveling in the first direction.

In an embodiment of the present invention, the first clamp 920 may travel in the first direction D1 while gripping the first electrode sheet 400a.

Referring to FIG. 10, before the first electrode sheet 400a enters the second web supply unit 600b, the clamp may be unfixed and be returned via the circulation belt 910. For example, before the first electrode sheet 400a enters the second web supply unit 600b, the first clamp 920 may be detached from the first electrode sheet 400a and returned via the circulation belt 910. The unfixed first electrode sheet 400a may continue to travel in the first direction D1.

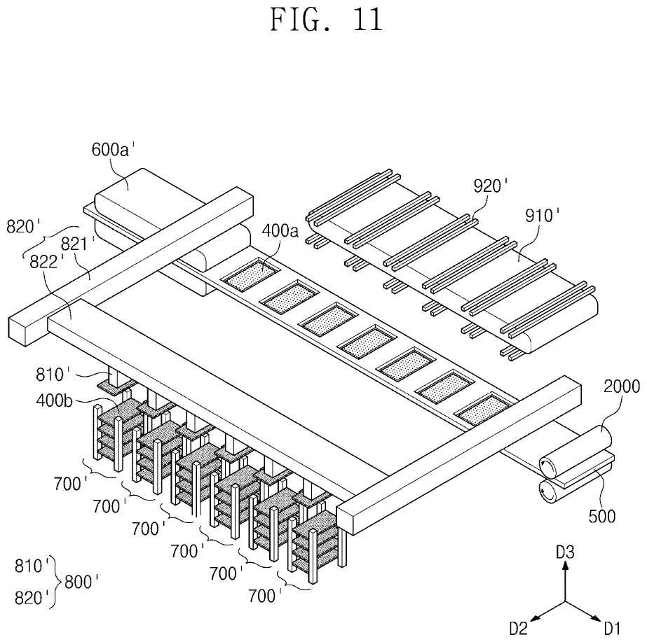

Referring to FIGS. 11 to 16, the second electrode sheet 400b may be seated on the pouch web 500 traveling by using the second stacking device 1000b.

The second stacking device 1000b may include a web supply unit 600′, a magazine unit 700′, a sheet supply unit 800′, and a sheet fixing unit 900′. The web supply unit 600′ may include a first supply unit 600a'. The sheet supply unit 800′ may include a sheet picking part 810′ and a carrier 820′. The carrier 820′ may include a support 821′ and a transport part 822′. The sheet fixing unit 900′ may include a circulation belt 910′ and a second clamp 920′ provided on one side of the circulation belt 910′.

Subjecting the second electrode sheet 400b to be seated in the pouch web 500 may be performed in the same manner as subjecting the first electrode sheet 400a to be seated in the pouch web 500.

For example, subjecting the second electrode sheet 400b to be seated on the pouch web 500 on which the first electrode sheet 400a is seated; fixing the seated second electrode sheet 400b with a second clamp 920′; subjecting the second clamp 920′ fixing the second electrode sheet to travel along the second direction; and detaching the second clamp 920′ from the second electrode sheet 400b may be included. Accordingly, a laminate 400c in which the second electrode sheet 400b is stacked on the first electrode sheet 400a may be formed.

In an embodiment of the present invention, the second clamp 920′ may travel in the first direction D1 at the same speed as the pouch web 500. For example, a first speed of the pouch web 500 traveling in the first direction may be the same as a second speed of the second clamp 920′ traveling in the first direction.

In an embodiment of the present invention, the second clamp 920′ may travel in the first direction D1 while gripping the second electrode sheet 400b.

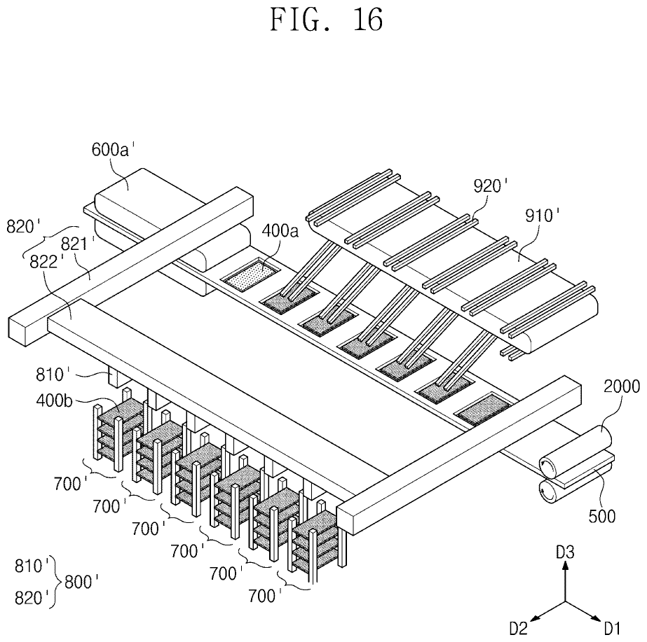

In an embodiment of the present invention, before the second electrode sheet 400b enters the lamination unit 2000, the second clamp 920′ may be unfixed and returned via a circulation belt 910′ (see FIG. 16).

The second electrode sheet 400b may include an electrode layer (positive electrode layer or negative electrode layer) different from an electrode layer (positive electrode layer or negative electrode layer) included in the first electrode sheet 400a, and an electrolyte layer formed thereon. For example, the first electrode sheet 400a may include a positive electrode layer 100 and a positive electrode electrolyte layer 300a, and the second electrode sheet 400b may include a negative electrode layer 200 and a negative electrode electrolyte layer 300b.

The second electrode sheet 400b may be seated on the first electrode sheet 400a to form a laminate 400c.

According to embodiments of the present invention, as a subsequent process, a lamination process and a pressing process may be performed on the laminate 400c that travels on the web in the first direction D1. The laminate 400c may be discharged in the form of a monocell after the pressing process.

Referring to FIG. 2, the pouch web 500 on which the laminate 400c is seated may be subjected to a lamination process through the lamination unit 2000 while traveling along the first direction D1.

In an embodiment of the present invention, the lamination process may include a rolling process. Through the lamination process, the first electrode sheet and the second electrode sheet 400b may be stably attached. For example, the positive electrolyte layer 300a of the first electrode sheet and the negative electrolyte layer 300b of the second electrode sheet 400b may be stably attached.

Referring to FIG. 2, the pouch web 500 on which the laminate 400c is seated may be subjected to a pressing process through the press unit 3000 while traveling along the first direction D1.

In an embodiment of the present invention, the pressing process may include a heating process. In an embodiment of the present invention, the pressing process may include a roll pressing process. Through the pressing process, a solid electrolyte layer 300 may be densified. An interface may be activated through the pressing process. For example, an interface between the positive electrolyte layer 300a and the negative electrolyte layer 300b may be activated through the pressing process.

The monocell manufactured through the pressing process may be discharged through the discharge unit 4000 while traveling in the first direction D1. The remaining pouch web may be wound around a pouch reel and recovered.

According to embodiments of the present invention, a sheet-like electrode may be transported through line traveling.

According to embodiments of the present invention, high pressure may be applied to a line traveling laminate 400c through roll pressing.

Although the embodiments of the present invention have been described above with reference to the accompanying drawings, the present invention may be applied in other specific forms without changing the technical idea or essential features thereof. Therefore, the above-described embodiments are to be considered in all aspects as illustrative and not restrictive.

1. A stacking device comprising a web supply unit, a magazine unit, a sheet supply unit, and a sheet fixing unit,
wherein the web supply unit is configured such that a pouch web travels in a first direction, and the pouch web comprises a space for receiving an electrode sheet,
the magazine unit is configured to receive a plurality of electrode sheets,
the sheet supply unit is configured such that the electrode sheet is picked up from the magazine unit and seated in the space of the pouch web,
the sheet fixing unit comprises a circulation belt and a clamp provided on one side of the circulation belt,
the clamp is configured to fix the electrode sheet seated in the space onto the pouch web, and
the circulation belt is configured such that the clamp circularly travels in the first direction.

2. The stacking device of claim 1, wherein the sheet transport supply unit comprises:
a picking part configured to pick up the electrode sheet; and
a carrier configured to transfer the picking part from the magazine unit to the pouch web.

3. The stacking device of claim 1, wherein the clamp comprises a plurality of clamps arranged at a predetermined interval along the first direction, and
the plurality of clamps are connected to the circulation belt.

4. The stacking device of claim 1, wherein the sheet fixing unit comprises:
a horizontal driving part configured to move the clamp in a second direction crossing the first direction; and
a vertical driving part configured to move the clamp in a vertical direction.

5. The stacking device of claim 1, wherein a first speed at which the pouch web travels in the first direction and a second speed at which the clamp travels in the first direction are the same.

6. The stacking device of claim 1, wherein the clamp travels in the first direction while gripping the electrode sheet seated in the space.

7. The stacking device of claim 1, wherein the electrode sheet comprises an electrode layer, and
the electrode layer is any one of a positive electrode layer and a negative electrode layer.

8. The stacking device of claim 7, wherein the electrode sheet further comprises a solid electrolyte layer provided on the electrode layer.

9. A method for manufacturing an all-solid-state battery, the method comprising:
subjecting a pouch web to travel along a first direction, the pouch web comprising a space for receiving an electrode sheet;
subjecting a first electrode sheet to be seated in the space of the traveling pouch web; fixing the seated first electrode sheet with a first clamp;
subjecting the first clamp fixing the first electrode sheet to travel along the first direction; and
detaching the first clamp from the first electrode sheet.

10. The method of claim 9, wherein the first clamp provided in plurality is disposed at a predetermined interval along the first direction on one side of a first circulation belt, and
the plurality of first clamps each contact the first electrode sheet to fix the first electrode sheet provided in plurality.

11. The method of claim 9, wherein a first speed at which the pouch web travels in the first direction and a second speed at which the first clamp travels in the first direction are the same.

12. The method of claim 9, further comprising:
subjecting the pouch web to continuously travel along the first direction after the detaching of the first clamp;
subjecting a second electrode sheet to be seated on the pouch web on which the first electrode sheet is seated;
fixing the seated second electrode sheet with a second clamp; and
detaching the second clamp from the second electrode sheet.

13. The method of claim 12, wherein a first speed at which the pouch web travels in the first direction and a second speed at which the second clamp travels in the first direction are the same.

14. The method of claim 12, further comprising laminating the pouch web on which the unfixed second electrode sheet is seated.

15. The method of claim 12, further comprising pressing the pouch web on which the unfixed second electrode sheet is seated.

16. The method of claim 15, wherein the pressing is roll pressing.
